(19) United States
(12) Patent Application Publication
(10) Pub. No.: US 2005/0280261 A1
(43) Pub. Date: Dec. 22, 2005

(54) Power energy generating apparatus for electricity generator

(76) Inventor: Kenei Oshiro, Itoman-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/030,287

(22) Filed: Jan. 7, 2005

(30) Foreign Application Priority Data
Jun. 22, 2004 (JP) 2004-212306

(51) Int. Cl. H02P 9/04; B25B 13/00

(52) U.S. Cl. 290/1 R

(57) ABSTRACT

A power energy generating apparatus for electricity generator comprises a rotating cylindrical body mounted rotatably by a shaft on a fixing base and having an inner periphery rotator and an outer periphery rotator. The inner periphery rotator of the rotating cylindrical body has a plurality of two headed weight bodies mounted pivotably and arranged radially about the shaft. Each two headed weight body includes two heads, a permanent magnet and spring receiving member fitted on one of said two heads, a supporting frame fitted pivotably on the inner end of the inner periphery rotator, and a weight setting member fitted on the supporting frame. In addition, the inner periphery rotator of the rotating cylindrical body has a plurality of stopping plates mounted radially about the shaft, and each stopping plate is arranged between the two headed weight bodies and is provided with a permanent magnet and a spring disposed oppositely to the permanent magnet and spring receiving member mounted respectively on the two headed weight body. The fixing base is provided with an electricity generator, a generating rotary power member connected to said electricity generator, a starting power member connected to the generating rotary power member, and a starting motor connected to the starting power member. The rotating cylindrical body is provided on the outer side with a rotation transfer gear engaging with the starting power member.

### BACKGROUND OF THE INVENTION

1. Field of the Invention

This invention relates to a power energy generating apparatus for electricity generator that generates power energies by its self-rotation of a rotating cylindrical body necessitating no external energies to be supplied.

2. Description of the Prior Arts

Conventionally in an electricity generator of this kind in order to secure power energies, for example, it is known that there is a power energy generating apparatus by heat loading or hydraulic loading or light loading.

In such a power energy generating apparatus by heat, hydraulic or light loading shown in the prior arts, there are problems wherein a wide space for installing the same should be required and energies in quantity should be required in the heating and lighting resources.

### SUMMARY OF THE INVENTION

It is an objects of the present invention to provide a power energy generating apparatus for electricity generator carried out in order to resolve those conventional problems as described above, and being capable of generating power energies by self-rotating a cylindrical body, which does not require wide space for installing and being superior in a sense of beauty in its small sized apparatus and also in generating power energies quite enough to supply therefore.

In order to achieve the above described object, a power energy generating apparatus according to an aspect of the invention comprises a rotating cylindrical body rotatably fitted by a shaft on a fixing base, and said rotating cylindrical body is provided with an inner periphery rotator and an outer periphery rotator. The inner periphery rotator of the rotating cylindrical body has a plurality of two headed weight bodies pivotably mounted radially about the shaft. Each two headed weight body is provided with a permanent magnet and a spring receiving member for seating a spring on each stopping plate. In addition, each two headed weight body is provided with a supporting frame pivoted on a shaft on the lower end portion of the inner periphery rotator and a weight setting member fitted on the supporting frame. The inner periphery rotator of the rotating cylindrical body has a plurality of the stopping plates fitted radially about the shaft, and each stopping plate is disposed between the two headed weight bodies and is provided with a permanent magnet and a spring disposed oppositely to the permanent magnet and the spring receiving member mounted respectively on the two headed weight bodies. The fixing base is provided with a electricity generator, a generating rotary power member connected to said electricity generator, a starting power member connected to said generating rotary power member and a starting motor connected to said starting power member, and the rotating cylindrical body is provided on the outer side with a rotation transfer gear engaged with the starting power member. The outer periphery rotator of the rotating cylindrical body is provided with a plurality of weight members and blades to function as a rotary starter.

According to the power energy generating apparatus for electricity generator of the present invention, the rotating cylindrical body is rotated at the time of starting on the basis of the external power supplied by the starting motor and after the rotating cylindrical body once rotates continuously, the rotation is conducted by itself without any external power supplied and at the same time, the rotary speed is accelerated enabling it to generate the engery for electricity generation. This means that the rotating cylindrical body itself generates energies and at the same time said energies can be supplied to the electricity generator, thereby the electricity generator can generate electric powers. Furthermore, a portion of the generated electric powers can also be supplied back to the starting motor.

As the rotating cylindrical body having the inner periphery rotary body and outer periphery rotary body is mounted on the fixing base, it is an advantage that the total set-up can be miniaturized not necessitating a wide space for that. The rotating cylindrical body comes to have an action of rotating independently because a plurality of the two headed weight bodies are fitted pivotably thereon, one head of the two headed weight body causes the vertical gravity based on the inner diameter difference at a vertical point and, at the same time, the other head causes the repulsion and attraction by means of the spring and permanent magnet, thereby the two headed weight body acts to create the rotation energies.

The two headed weight bodies disposed between the stopping plates are contacted with and detached from the stopping plates by means of permanent magnet and spring on the basis of the gravity of the two headed weight body actuated depending on the rotating position of the rotating cylindrical body.

Consequently, the gravity and centrifugal force created by the pivot movement of the two headed weight body can accelerate the rotational speed.

### BRIEF DESCRIPTION OF THE DRAWINGS

FIG. 1 is an elevation view of the power energy generating apparatus for electricity generator according to the present invention;

FIG. 2 is a schematic side view of the power energy generating apparatus according to the present invention;

FIG. 3 is a perspective view of the rotating cylindrical body according to the present invention.

FIG. 4 is a perspective view of the two headed weight body according to the present invention.

FIG. 5 is a side view of the two headed weight body according to the present invention; and

FIG. 6 is a side view to show an actuation of the continuous rotation of the two headed weight body according to the present invention.

### DETAILED DESCRIPTION OF THE PREFERRED EMBODIMENTS

A power energy generating apparatus (A) for electricity generator according to the present invention comprises a rotating cylindrical body 1 rotatably in arrow direction fitted by means of a shaft 10 on a fixing base 15. The rotating cylindrical body 1 includes a plurality of frames 11, 11 fitted on the hub of the shaft 10, an inner periphery rotator 9 mounted on the upper ends of said frames 11, 11 and an outer periphery rotator 4 fitted on the outer periphery of said inner periphery rotator 9.

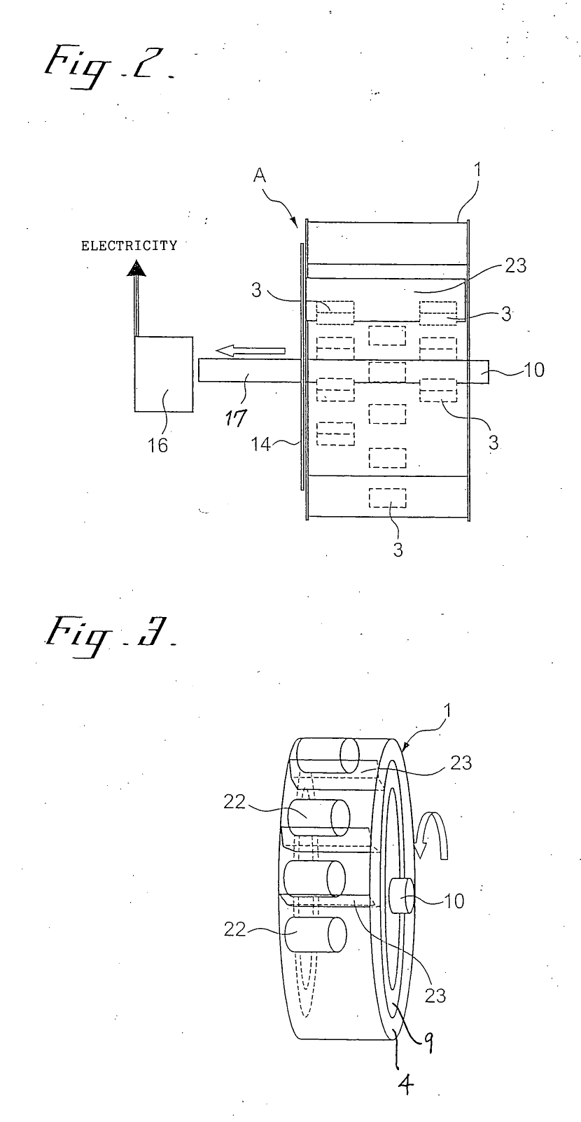

The inner periphery rotator 9 of the rotating cylindrical body 1 is provided with a plurality of two headed weight bodies 3, 3 fitted pivotably in three rows, along the width of the inner periphery rotator 9, at the center portion and both sides thereof as shown in FIG. 2, and, at the same time, arranged radially on the shaft 10. The two headed weight bodies 3, 3 is required to provide a fixed number in order to get the rotating cylindrical body 1 continuously rotated, for example, it is required to dispose 18 sets of the two headed weight body 3 respectively on both sides thereof and, 27 sets of the two headed weight body 3 in the center of the rotating cylindrical body 1.

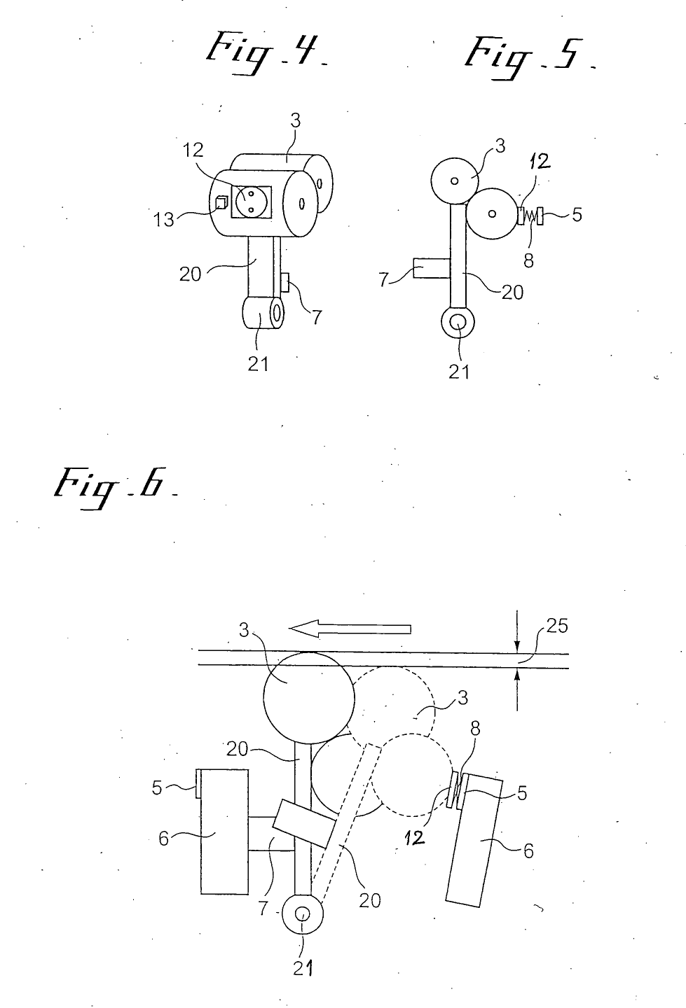

Each two headed weight body 3 is provided with two heads and a supporting frame 20 fitted pivotably by a shaft 21 to the inner edge of the inner periphery rotator 9, as shown in FIGS. 4 and 5, and one of the two heads is fitted with a permanent magnet 12 and with a spring receiving member 13 for seating a spring 8 fitted on each stopping plate 6 and, said supporting frame 20 is protrudingly provided on one side thereof with a weight setting member 7 to stop the pivot movement of the two headed weight body.

Furthermore, the inner periphery rotator 9 of the rotating cylindrical body 1 is provided with a plurality of stopping plates 6, 6 which are fitted radially about the shaft 10 and arranged between the two headed weight bodies 3 and 3. Each stopping plate 6 is provided with a permanent magnet 5 and spring 8 attached so that they are corresponded to the permanent magnet 12 and the spring receiving member 13 fitted on the two headed weight body 3. The permanent magnet 5 is arranged to place face to face with the same positive pole with the other permanent magnet 12 so as to create the repulsive force.

The fixing base 15 is provided with an electricity generator 16, a starting motor 19 to start the rotation of the rotating cylindrical body and a starting power member 18 connected to the starting motor 19, wherein the starting power member 18 is connected to the generating rotary power member 17 and the starting power member 18 is engaged with a rotation transfer gear 14 attached to the outer side of the rotating cylindrical body 1.

The outer periphery rotator 4 of the rotating cylindrical body 1 is provided with a plurality of weight members 22, 22 and blades 23, 23 fitted radially about the shaft 10. The weight members 22 and blades 23 are acted by use of sand or water, as a rotation starter to get the rotation of the rotating cylindrical body 1 started. The weight members 22 can also function as a rotary accelerator on basis of the gravity and centrifugal force thereof.

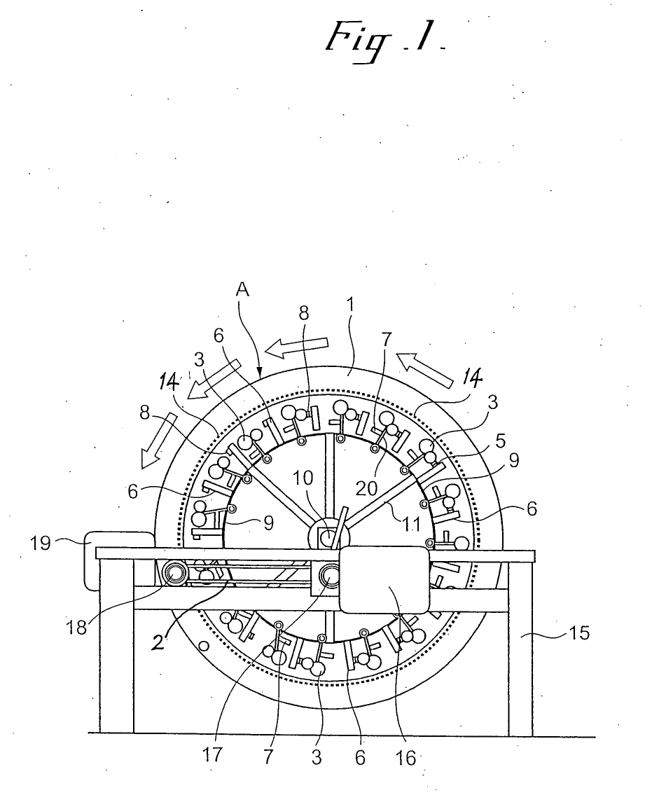

The operation of the power energy generator for electricity generator in accordance with the present invention would be hereinunder explained in detail. As first step, the starting motor 19 (or rotation starter of weight members 22 and blades 23 by use of sand water shown in FIG. 3) is operated to rotate the rotation transfer gear 14 through the rotation of the starting power member 18 and thereby operate a continuous rotation of the rotating cylindrical body 1 in arrow direction shown in FIG. 1 which supply the rotating energy to the generating rotary power member 17.

When the rotating cylindrical body 1 is rotated in arrow direction, the two headed weight bodies 3 positioned on the left side between the utmost upper end position and the utmost lower end position of the rotating cylindrical body 1 are pivoted about the shaft 21 to the downward direction by the gravity based on the inner diameter difference 25 at the vertical point and detached from the stopping plates 6 which were in a joining relation each other, and the weight setting members 7 of said two headed weight bodies 3 are contacted with the stopping plates 6 arranged in the forward direction thereof and such a series of pivot movements of the two headed weight bodies 3 to the stopping plates 6 impart the rotary energy to the rotating cylindrical body 1. Therefore, while the two headed weight bodies 3 are moved from the utmost upper end portion to the utmost lower end position in the downward direction by following the rotation of the rotating cylindrical body 1, the rotation of the rotating cylindrical body can be accelerated by means of the gravity and centrifugal force of the two headed weight bodies 3.

Similarly, the two headed weight bodies 3 positioned on the right side from the utmost lower end position to the utmost upper end position of the rotating cylindrical body 1 are pivoted by means of the gravity so as to detach the weight setting members 7 from the stopping plates 6, thereby the permanent magnets 12 and the spring receiving members 13 of the two headed weight bodies 3 are to come to join the permanent magnets 5 and the springs 8 of the stopping plates 6 located its backward, and by the repulsive force created between the permanent magnets 12 and the permanent magnets 5 and between the spring receiving members 13 and springs 8 respectively, the rotation energy is imparted to the rotating cylindrical body 3. Therefore, the rotation of the rotating cylindrical body 1 is accelerated by the repulsive forces created by the permanent magnets and the springs, while the two headed weight bodies 3 are moved from the utmost lower end position to the utmost upper end position by following the rotation of the rotary cylindrical body 1.

Consequently, the rotation of the rotating cylindrical body 1 is accelerated by the two headed weight bodies 3 which are actuated in the first rotation of the rotating cylindrical body 1 in arrow direction, and then the rotating cylindrical body 1 is continuously rotated by itself independently to build up the generating power energy.

The continuous rotation of the rotating cylindrical body 1 is transferred by the rotation transfer gear 14 to the starting power member 18 as electricity generating energy and then is transferred by the rotating chain 2 from the starting power member 18 to the generating rotary power member 17 and at last is supplied to the rotor of the generator 16 to generate the electric power.

1) A power energy generating apparatus for electricity generator comprising:
a rotating cylindrical body rotatably mounted on a fixing base and having an inner periphery rotating body and an outer periphery rotating body;
a plurality of two headed weight bodies attached radially to the inner periphery rotator, wherein each of said two headed weight bodies includes a supporting frame fitted pivotably on the inner periphery rotator, a weight setting member fitted to said supporting frame, a permanent magnet, and a spring receiving member;
a plurality of stopping plates fitted radially on the inner periphery rotator of the rotating cylindrical body, wherein each of said stopping plates is arranged between the two headed weight bodies and has a permanent magnet and a spring disposed so as to correspond with the permanent magnet and the spring receiving member fitted to each of the two headed weight bodies;
an electricity generator, a generating rotary power member connected to said electricity generator and a starting power member disposed respectively on the fixing base;
a rotation starter connected to the generating rotary power member for starting the rotation of the rotating cylindrical body; and,
a rotation transfer means engaged to said starting power member and mounted to the rotating cylindrical body.

2) The power energy generating apparatus according to claim 1, wherein the rotation starter comprises a starting motor fitted on the fixing base.

3) The power energy generating apparatus according to claim 1, wherein the rotation starter comprises a plurality of weight members and blades fitted on the outer periphery rotator of the rotating cylindrical body for rotating the rotating cylindrical body by means of water or sand.

4) The power energy generating apparatus according to claim 1, wherein the starting power member is connected by means of a rotating chain to the generating rotary power member.

5) The power energy generating apparatus according to claim 1, wherein the rotation transfer means comprises the rotation transfer gear fixed to the outside of the rotating cylindrical body.
